(19) United States
(12) Patent Application Publication
(10) Pub. No.: US 2015/0334070 A1
(43) Pub. Date: Nov. 19, 2015

(54) Send2Mobile Cloud System

(71) Applicants: Jeffrey N. Dinardo, JR., Babylon, NY (US); Jeffrey N. Dinardo, SR., Islip, NY (US)

(72) Inventors: Jeffrey N. Dinardo, JR., Babylon, NY (US); Jeffrey N. Dinardo, SR., Islip, NY (US)

(21) Appl. No.: 14/545,891

(22) Filed: Jul. 2, 2015

Related U.S. Application Data
(63) Continuation-in-part of application No. 13/998,801, filed on Dec. 9, 2013.

(51) Int. Cl. H04L 12/58; H04L 29/06; G06Q 30/02; G06Q 20/36; H04W 4/02; G06F 21/62; G06Q 30/06

(52) U.S. Cl. CPC H04L 51/24; G06F 21/6218; H04L 63/102; G06Q 30/0641; G06Q 20/36; G06Q 30/0633; H04W 4/025; G06Q 30/0261; G06Q 30/0267

(57) ABSTRACT

The present invention is a cloud-based remote Platform as a Service (PaaS) system, which utilizes a short message service (SMS), multi-media message service (MMS) and enhanced messaging service (EMS) based platforms to create an interactive communication and a reverse marketing system, providing merchants, retailers and/or sellers the means to rapidly and effectively communicate with their respective customers or customer base. By embedding the present invention onto each product page of the merchant or retailer's website, the merchant and/or retailer is providing its respective customers with the ability to directly communicate with the merchant and/or retailer, in nearly real time. At the same time, since the present invention resides in a cloud-based remote PaaS server environment, the customer has a secure log-in to their own personal portal page within this cloud-based system, which can be accessed through log-in on either the cloud-based website or the cloud-based mobile application. The customer can store a plurality of product pages previously designated by the customer and forwarded by the customer to their individual designated portal, allowing the customer to easily view, share and/or purchase those products previously stored within their portal or to communicate directly with the merchant or retailer with questions, comments or counter-offers concerning the individual products chosen. The present invention also employs the Global Positioning System (GPS) locator service, which communicates with the customer's mobile device, through JAVA coding and uses tracking algorithms to alert the customer, via SMS, MMS or EMS alerts, of the location of participating merchants and/or retailers and a plurality of shopping events and product specific information.

This application is a Continuation-in-Part of application Ser. No. 13/998,801 filed on Dec. 9, 2014.

### BACKGROUND OF INVENTION

1. Field of Invention

This present invention relates to providing personal access through an i-Phone, smartphone or other mobile device or electronic computing device and a method of registering a personal cloud account (PPA) within a remote private cloud portal server, in order to permit the User to store and share product information and content, to communicate via connected and interfaced SMS/MMS/EMS platform directly to a merchant, retailer or seller of product or services, in order to make offers, counter-offers, bids or counter-bids for the purchase of products and/or services and to initiate immediate payment for products and/or services, through a “buy now” mobile wallet integrated and residing in the User's personal portal account of the remote private cloud portal server.

2. Description of Related Art

The information provided in this background summary is only to assist with an understanding of the present invention. No determination has been made, and no assertion is made, as to whether any of the below might be applicable as prior art with regard to the present invention.

Each day, more and more information and content becomes available to the individual and each day, newer communications technologies are being developed to assist the individual in managing and processing the information and content available. In the present invention, a private cloud server portal is provided to the individual in order to store various types of content and information and to provide the individual the ability to download and share said content and information from the individual's private cloud server portal, anytime and anywhere using an i-Phone, i-Pad, smartphone, PC or any other similar electronic device.

Cloud computing networks provide services, which interact with the User's data, software and computation systems over multiple networks. The User accesses cloud based applications through a web browser, or a light-weight desktop or mobile application, while the remainder of the light-weight application software and data are stored on cloud servers in remote locations. Cloud computing provides better service and performance with cloud software programs, just as if the cloud software programs were actually installed, located and residing on the User's PC, iPhone, PC tablet, or similar mobile electronic device.

Existing public cloud services typically involve a structure in which a server with a fixed infrastructure, is accessed by clients, through an electronic device, and using a fixed internet identifier such as an IP address or domain number. These public cloud storage systems utilize an existing Network Attached Storage (NAS) system, wherein the NAS system uploads or downloads and shares content and information by using a plurality of electronic devices such as iPhone, iPad, smartphone, PC, tablet PC and smart TV. The existing public cloud services provide for a public cloud server, which is shared by multiple Users. As a result, certain problems and issues exist. One issue is how to efficiently store and retrieve electronic content and information, if the User is an individual and not a company or institution. Another problem is providing proper privacy and security for electronic content and information stored and retrieved on cloud computing networks. Yet another problem is exactly where on a cloud computing network to store and retrieve private, secure individuals' electronic content and information. Therefore, it is desirable to solve the problems associate with information and content now stored in public cloud computing networks.

Resultantly, there is a need to develop a personal cloud method and system, whereby the User can securely store content and information, both personal and financial, and only after proper identification and authentication protocols are initiated and followed, can access his/her stored content and information, further upload content and information, download content and information, share content and information and initiate an interaction with merchants, retailers and sellers, such as requests for further information, payment, offers of purchase, bids, counter-bids and counter-offers for products and/or services, prior identified for purchase by the User. A plurality of these actions are initiated through a connected and interfaced SMS/MMS/EMS platform, connected to the private cloud system

The present invention addresses the need for a personal cloud method and system and offers Users private, secure access to their individualized private portal account (PPA), which contains the personal content and information previously stored in the PPA by the User for later reference, download, sharing or further interactions with merchants, retailers or sellers of product and services, such as requests for specific product information, payment for products and services; offers to purchase; offers to bid; counter-offers; counter-bids, which will be effectuated via a connected and interfaced SMS/MMS/EMS platform within the private cloud system. A “private cloud” is essentially the emulation of a public cloud operating on a private network, such as in the present invention, the closed network of the Send2Mobile system. Through virtualization, a private cloud gives an enterprise the ability to host applications on virtual machines enterprise-wide. This provides benefits of shared hardware costs, better service recovery and the ability to scale up or scale down depending on demand. In this present invention, the User's private data is kept in the public cloud only when it is currently being accessed by the User through the User's PPA. However, the User's private data, for security concerns is only temporarily transferred over the public network in an encrypted form and then only temporarily stored in the public cloud in this encrypted form. In this way, the User's contents and information contained within the user's PPA, always remains private and secure. The Send2Mobile system uses security and/or encryption application programs integral to and/or separate from the private cloud applications. Security and/or encryption programs also exist in the hardware components on the network devices described herein and/or exist in a combination of hardware, software and/or firmware; such as Wireless Encryption Protocol (WEP); RC4 cipher designed by RSA Data Security, Inc.; and/or Robust Security Network (RSN) protocols. All of these protocols can be supported by the Secure Sockets Layer (SSL) protocol, the recognized security protocol for digital payment technology.

### SUMMARY OF THE INVENTION

Aspects of the present invention are to address at least the above-mentioned problems and/or disadvantages and to provide the advantages described below. Accordingly, an aspect of the present invention is to provide a user with private, secure access via a PC, smartphone, iPhone, iPad, PC tablet or other similar electronic device, to personal cloud storage, through the establishment of a private portal account (PPA), which can only be accessed by the User after the initiation of and compliance with prior established and integrated security protocols, more particularly described herein, designed for the secure identification and authentication of the User.

In accordance with an aspect of the present invention, after the User has completed the security log-in protocols and has been properly identified and authenticated, the User is granted access to its private portal account (PPA) wherein the User has direct access to all information and content previously stored by the User in its PPA, such as a listing of all products previously sent to the User's PPA by the User, via the User choosing an enabled Send2Mobile retailer, merchant or seller's website. The User may opt to send the product information to the User's individualized PPA by clicking on the link or icon or button provided on the Send2Mobile enabled website product page. Once the User has acted to click on the Send2Mobile link, button or icon located on the product page of the retailer, merchant or seller's Send2Mobile enabled website, the Send2Mobile system then pushes the chosen product page to the User's individualized PPA for storage and future reference and/or action. Further actions that the User can execute directly from its PPA include, review of its saved listings; downloading and sharing the User's favorite products with other contacts and friends or payment for a product previously chosen and stored in the PPA via an integrated digital wallet solution. The User's individualized and secure PPA contains the User's billing and shipping information and encrypted payment information, so that once the User elects to purchase a previously stored product in its PPA, with the click of one button, the PPA system can charge the User's stored credit card and all of the pertinent order and payment details are forwarded to the retailer, merchant or seller's payment portal for authentication and purchase authorization. Simultaneously, via an integrated SMS/MMS EMS platform, the Send2Mobile system will text a message to the User's chosen smartphone, iPhone or similar electronic, mobile device, which will also contain all of the User's pertinent order and payment details.

According to another aspect of the present invention, is the enrollment of Send2Mobile enabled merchants′, retailers' and/or sellers' websites. Once a merchant has successfully applied and enrolled with the Send2Mobile system, the enrollee will be supplied with Send2Mobile system coding to be added to their respective websites. This Send2Mobile coding when added to the respective enrollees' websites, will integrate the features offered by the Send2Mobile system; such as adding a “send to me′ icon, which when selected will push a product page to a Send2Mobile User′ individualized PPA for storage and future reference and/or action; adding a “buy now” button or icon, which when selected, will permit the Send2Mobile User to purchase the product immediately from their chosen smartphone; iPhone or similar electronic mobile device, via an integrated mobile wallet; and adding a drop down menu icon onto the product page, which when selected will contain a plurality of events and/or inquiries that can be chosen by the Send2Mobile User for inquiries to be sent through the Let Me Know function of the Send2Mobile system.

The drop down menu can be customized by the Send2Mobile enrollee to include a plurality of events such as new sales price of the product; the product now comes in newer models; the product is now re-stocked; the product is now offered in new colors and styles and so on. The enrollee in the Send2Mobile system will have added code to their respective websites to detect the drop down menu events and to send text message replies to the respective Send2Mobile Users via the integrated SMS/MMS/EMS platforms.

The Let Me Know function allows the Send2Mobile User to communicate directly with the enrolled Send2Mobile retailer, merchant or seller, via an integrated SMS/MMS/EMS platform. The Send2Mobile User can then use the drop down menu to communicate directly with the enrollee in order perform such actions as: product specific inquiries; making an offer to purchase the product at a lesser price; placing a bid or counter-bid for the product in an on-line auction environment; or choosing to immediately purchase the product via an integrated mobile wallet. The use of the Let Me Know function by the Send2Mobile User enables the User to take a more pro-active role in the purchase process; it effectively creates a “reverse marketing” environment, wherein the User is informing the merchant, retailer and or seller, what products they are ready to buy and under what conditions and what price they are willing to buy now.

According to another aspect of the present invention, is the embodiment of a real-time location detection system, which uses both MEMS (Micro-electro-mechanical Systems) and GPS (Global Positioning Services) sensors to achieve location-prediction with a high measure of accuracy. Real-time location detection allows for the location-based applications of the Send2Mobile+ system such as S2M enabled retail, restaurant and hospitality location finding, targeted ads, auctions and promotional events.

Other aspects, advantages and salient features of the invention will become apparent to those skilled in the art from the following detailed descriptions, which, when take in conjunction with the annexed drawings, discloses various embodiments of the present invention

### BRIEF DESCRIPTION OF DRAWINGS

FIG. 1 is a conceptual diagram of the private cloud system creating a method of secure storage and secure retrieval of User content and information.

FIG. 2 is a conceptual diagram of the method of storage of the User's content and information in the User's private portal account (PPA) hosted on the private cloud network.

FIG. 3 is a conceptual diagram of the method of retrieval by the User of its content and information stored in the User's private portal account (PPA) hosted on the private cloud network.

FIG. 4 is a conceptual diagram of the method of retrieval by the User of a stored Send2Mobile+ enabled product page and the transmittal of said product page to the User's targeted device, wherein User then activates the Let Me Know function coded on the product page and via the integrated SMS/MMS/EMS platform, transmits a text message directly to the respective merchants′, retailers' and/or sellers' virtual telephone number housed on their respective data base servers.

FIG. 5 is a conceptual diagram of the method of retrieval by the User of a stored Send2Mobile+ enabled product page and transmittal of said product page to the User's targeted device, wherein the User then activates the Send to Me function coded on the product page and via the integrated SMS/MMS/EMS platform, forwards a text message containing the product page to a friend or contact to share.

FIG. 6 is a conceptual diagram of the method of retrieval by the User of a stored Send2Mobile+ enabled product page and the transmittal of said product page to the User's targeted device, wherein the User the activates the “Buy Now” function coded on the product page and via the integrated mobile wallet residing on the User's targeted device, the User immediately purchases the product and the User's billing and shipping preferences, previously stored in the User's secure private portal account (PPA) are seamlessly applied to the purchase transaction.

FIG. 7 is a flow chart representation demonstrating the method of locating the geographic positioning of the User's mobile device and comparing that geographic positioning with the database content of the Send2Mobile+ enabled merchants, retailers and/or sellers in that parameter, wherein the User via the integrated SMS/MMS/EMS platform receives text messages of the location of said merchants, retailers and/or sellers and notifications of a plurality of events such as promotional sales, on-line auctions of products, targeted ads and the like.

### DETAILED DESCRIPTION OF DRAWINGS

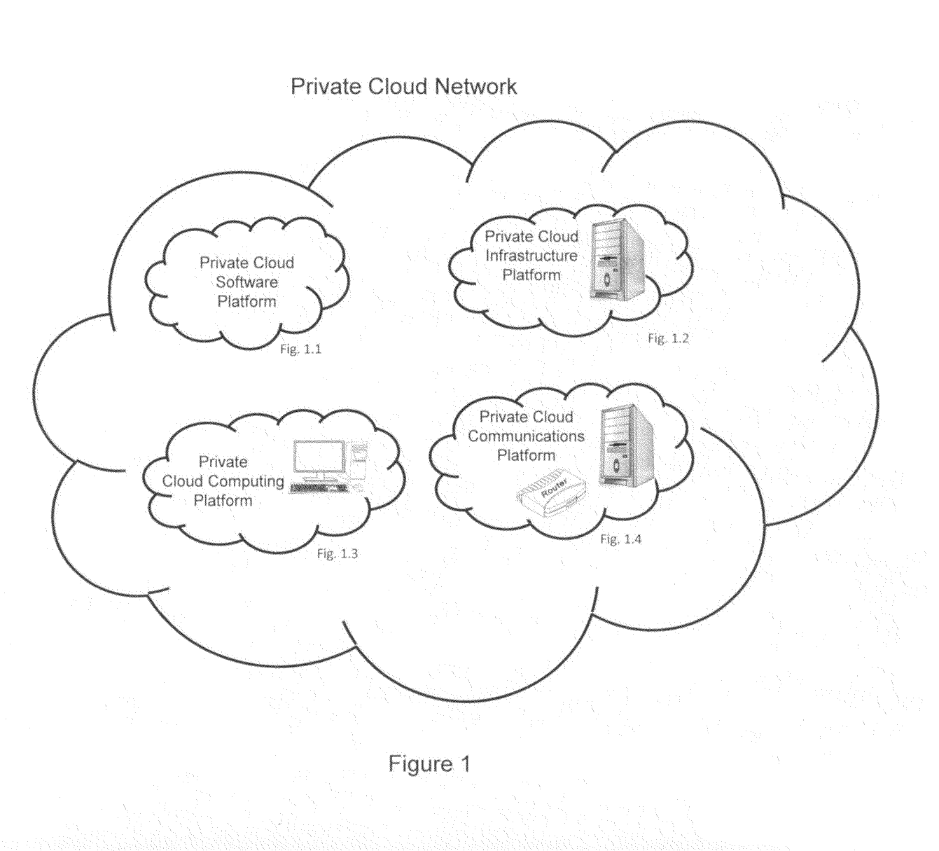

FIG. 1 is a conceptual diagram of a system creating a private cloud network for hosting of individual private portal accounts (PPA). The PPA is created and configured in the private cloud software platform 1.1 and is assigned a location address. The location address registry is located in the data base of the private cloud infrastructure platform, which stores the content, for security purposes, in various segregated layers 1.2. The private cloud computing platform 1.3 provides for the integration of other system platforms such as communications platforms, payment platforms, specific display platforms, The private cloud communications platform 1.4 hosts the router and other communication devices to provide for direct communication from the PPAs to targeted electronic devices outside of the network.

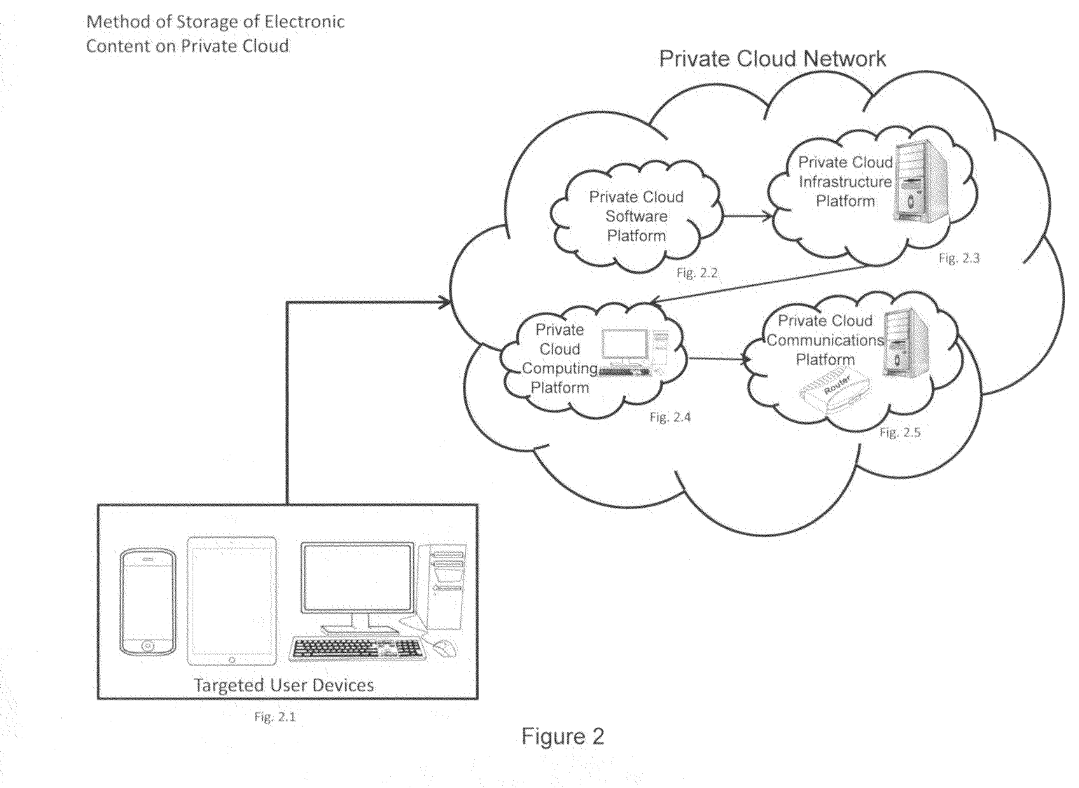

FIG. 2 is a conceptual diagram for creating a private cloud network system to accept electronic content and information transmitted by a targeted electronic device, to be stored in a segregated private portal account (PPA). The targeted device, through integrated software contained and hosted in the private cloud software platform 2.2, transmits electronic content and information from the targeted device for storage in the PPA hosted on the private cloud network. The electronic content and information accepted is then stored in the segregated PPA and the PPA is assigned an identifying registry address in the private cloud infrastructure platform 2.3. The electronic information and content stored in the PPA, for security purposes, is stored within different layers of the system and the private cloud computing platform 2.4 contains software to permit the assembly of these different layers into the one identifying registry address, when said registry address is called upon for retrieval 2.4. The private cloud communications platform 2.5 accesses the identified registry address of the PPA and performs the function of transmittal of the retrieved electronic content and information to the final targeted device.

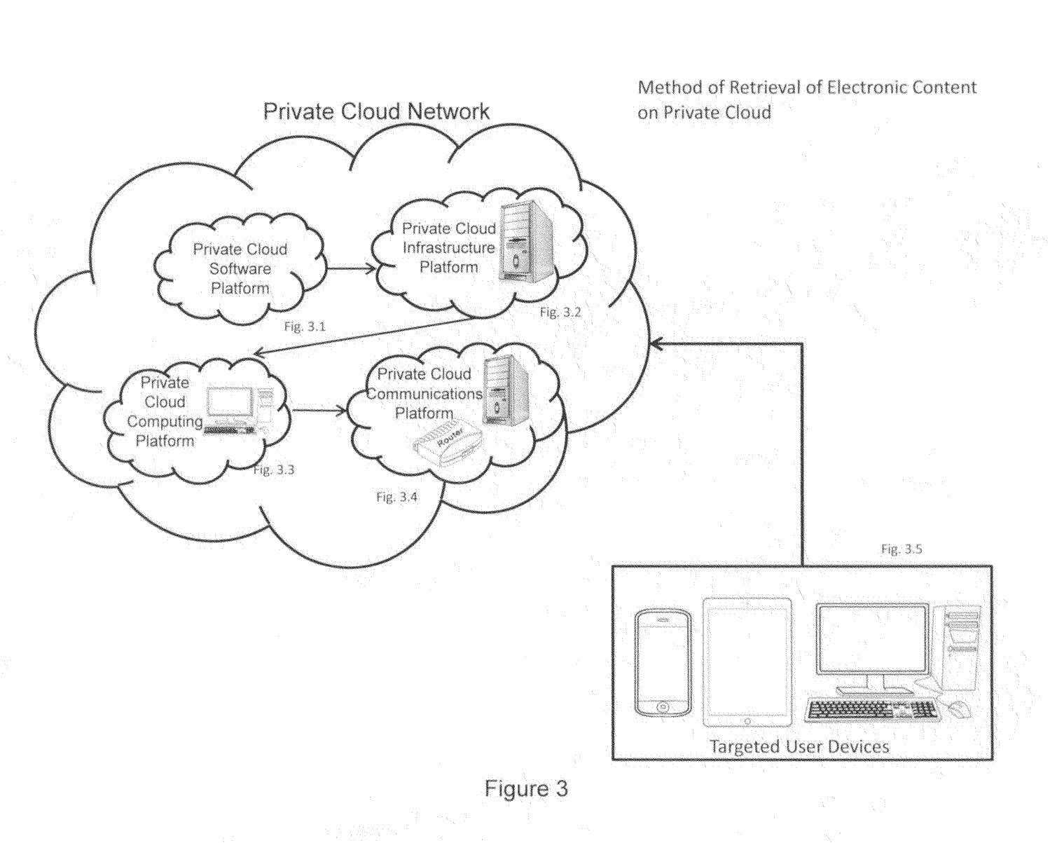

FIG. 3 is a conceptual diagram for creating a private cloud network system to retrieve electronic content and information transmitted by a targeted electronic device, and stored in a segregated private portal account (PPA). The targeted device, through integrated software contained and hosted in the private cloud software platform 3.1, transmits instructions to retrieve identified electronic content and information from storage in the PPA hosted on the private cloud network. The electronic content and information requested to be retrieved is then identified in the segregated PPA by a previously registry address in the private cloud infrastructure platform 3.2. The electronic information and content stored in the PPA, for security purposes, is stored within different layers of the system and the private cloud computing platform 3.3 contains software to permit the assembly of these different layers into the one identifying registry address, when said registry address is called upon for retrieval 3.3. The private cloud communications platform 3.4 accesses the identified registry address of the PPA and via coding sends the retrieved content and information through the system router to the final targeted device.

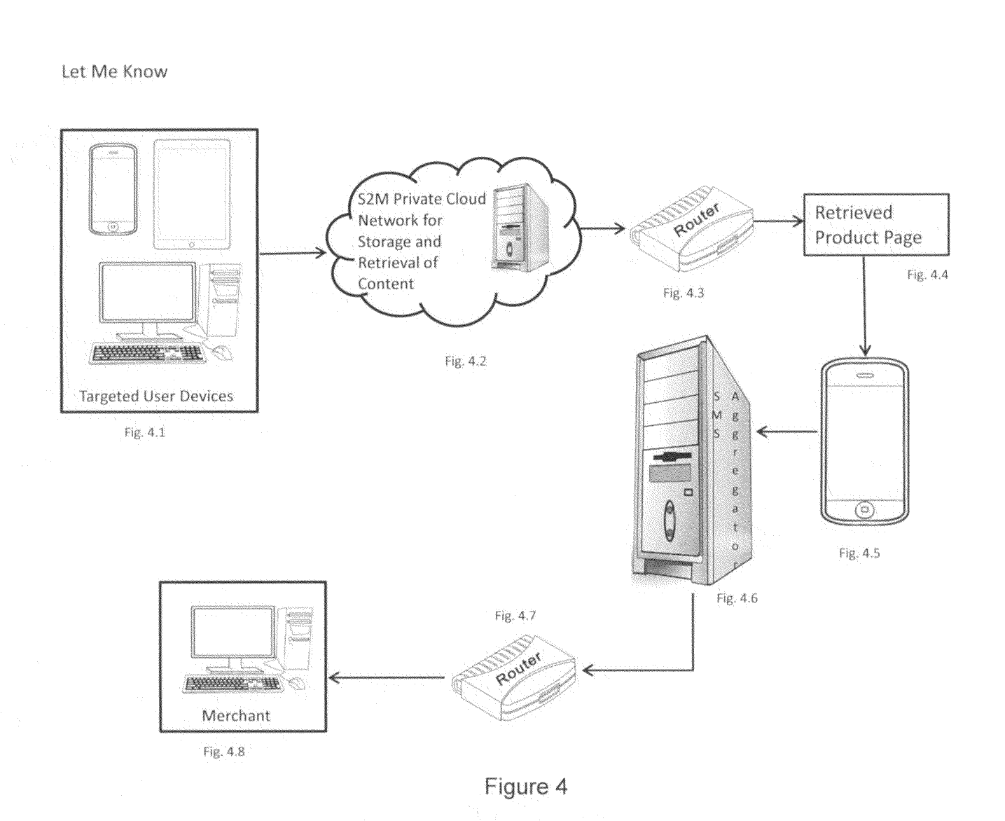

FIG. 4 is a conceptual diagram of a system for retrieving Send2Mobile+ enabled product pages from an individual PPA previously stored in the private cloud network. The User through a targeted electronic device 4.1, transmits instructions to the private cloud network to retrieve electronic content in the form of a previously stored product page from the individual's PPA 4.2. The private cloud network identifies the registry address for the retrieved information and passes said address through the private cloud network communication platform 4.2 with instructions to the system router 4.3 to forward the retrieved product page 4.4 to the User's targeted device 4.5.

Once the User receives the product page on its targeted device, the User enables the coded Let Me Know function by clicking on the Let Me Know icon on the product page. The User chooses from a plurality of events located on the drop-down menu of the Let Me Know function appearing on the product page and via the integrated SMS/MMS/EMS platform, elects to send a text message to the merchant's virtual telephone number 4.6, through the router 4.7, and onto the merchant's website.

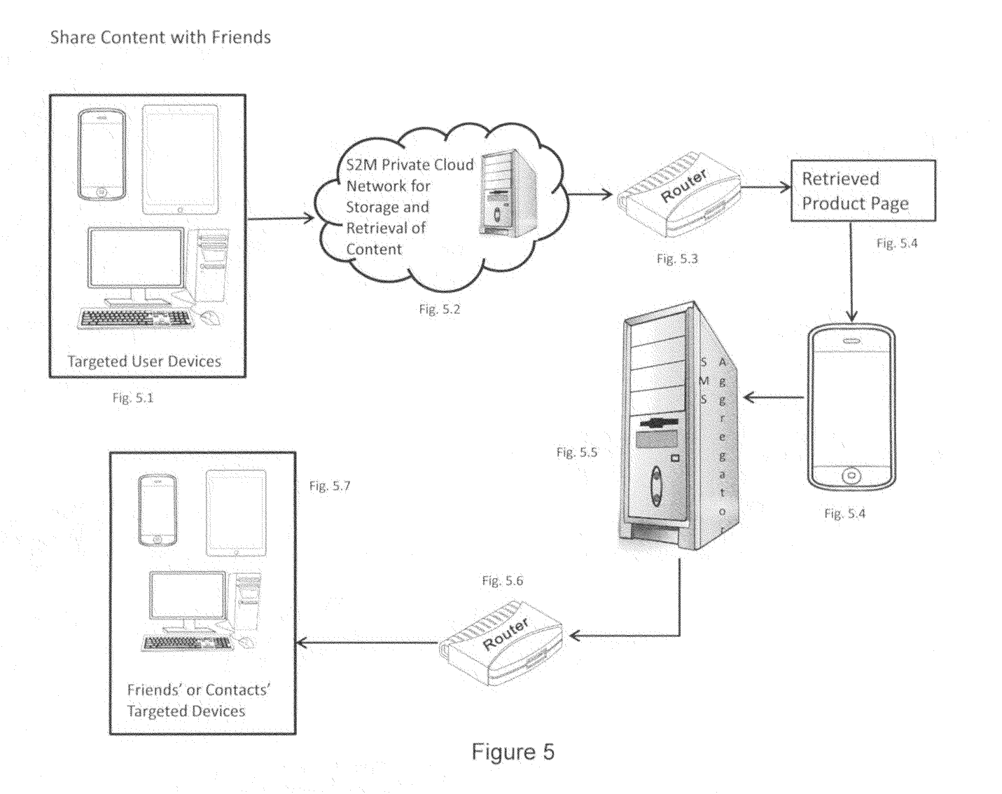

FIG. 5 is a conceptual diagram of a system for retrieving Send2Mobile+ enabled product pages from an individual PPA previously stored in the private cloud network. The User through a targeted electronic device 5.1, transmits instructions to the private cloud network to retrieve electronic content in the form of a previously stored product page from the individual's PPA 5.2. The private cloud network identifies the registry address for the retrieved information and passes said address through the private cloud network communication platform 5.2 with instructions to the system router 5.3 to forward the retrieved product page 5.4 to the User's targeted device 5.5.

Once the User receives the product page on its targeted device, the User enables the coded Share Content with Friends function by clicking on the Send to Friends icon on the product page. The User then chooses what friends and/or contents will receive the product page, enters their respective telephone numbers which will receive the text message and embedded product page and via the integrated SMS/MMS/EMS platform, elects to send a text message to the friends' and/or contacts' telephone number 5.5, through the router 5.6, and onto the friends and/or contacts' targeted device 5.7.

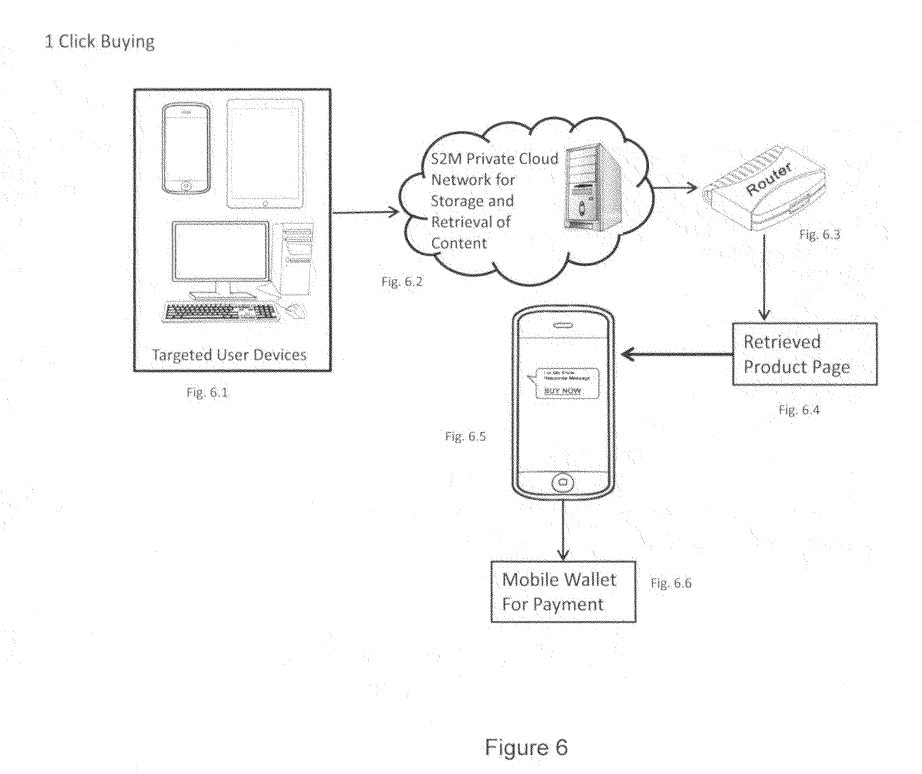

FIG. 6 is a conceptual diagram of a system for retrieving Send2Mobile+ enabled product pages from an individual PPA previously stored in the private cloud network. The User through a targeted electronic device 6.1, transmits instructions to the private cloud network to retrieve electronic content in the form of a previously stored product page from the individual's PPA 6.2. The private cloud network identifies the registry address for the retrieved information and passes said address through the private cloud network communication platform 6.2 with instructions to the system router 6.3 to forward the retrieved product page 6.4 to the User's targeted device 6.5.

Once the User receives the product page on its targeted device, the User enables the coded Buy Now function by clicking on the Buy Now icon on the retrieved product page. The User then chooses what mobile wallet it will use for the payment, from the mobile wallets residing on the User's targeted device 6.5. The mobile wallet will then make an immediate purchase of the respective product and the shipping and billing options stored by the User on its PPA account will interface with the payment module in making the final payment instruction 6.6.

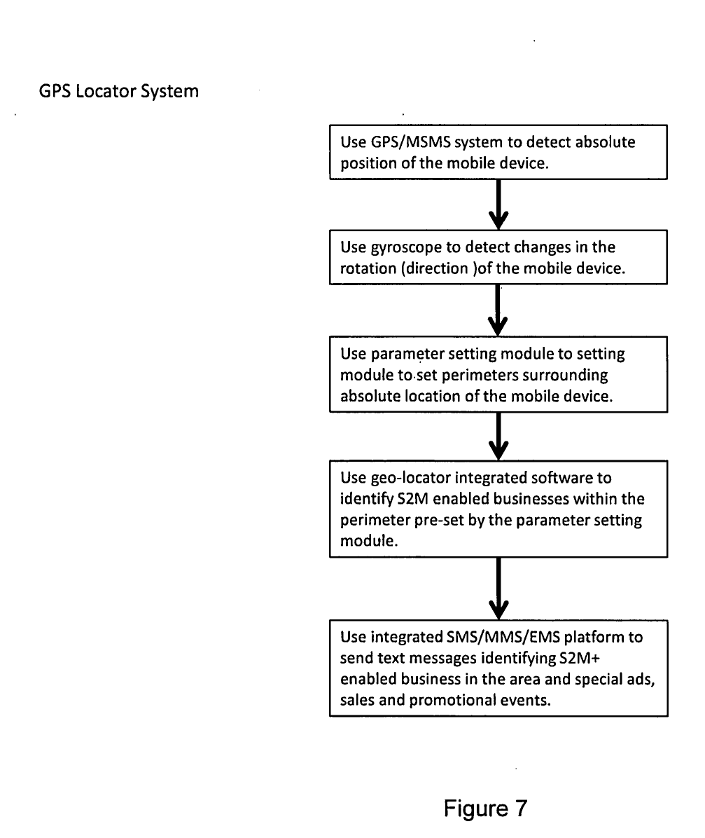

FIG. 7 is a flow chart representation of the method and system of locating the User's mobile device within a specific geographic perimeter. The system uses the GPS/MSMS embedded within the mobile device to triangulate an absolute position of the mobile device. Once an absolute position has been fixed for the device a gyroscope is employed to detect changes in the movement of the device within the absolute location. A parameter setting module then sets the limits of the perimeter surrounding the absolute location of the device and a geo-locator with integrated software identifies all S2m+ enabled merchants, retailers and/or sellers within the pre-set perimeter of the mobile device. The software then interfaces with the integrated SMS/MMS/EMS platform to send the User's mobile device text messages from S2M+ enabled businesses within the perimeter with text messages contain a plurality of events such as special ads, sales and promotional events.

What is claimed is:

1. A method for automatic storage of electronic content within a private cloud computing network, comprising;
receiving electronic content on a private cloud application and storing it in a first non-transitory computer readable medium on a private cloud server network device with one or more processors via a cloud communications network comprising of one or more private networks;
splitting the received electronic content received within the private cloud application into a plurality of portions;
saving within the private cloud application a plurality of portions of electronic content in a plurality of cloud storage objects;
determining a plurality of address locations of a plurality of different cloud server network devices, each within one or more processors,
wherein the address location can be located anywhere on the one or more private cloud communications networks;
storing securely the determined plurality of address locations in a cloud content location map within the private cloud application in the first non-transitory computer readable medium on the private cloud server network device;
wherein none of the selected ones of the plurality of other cloud server network devices can individually determine locations of all portions of the received electronic content for storage on the private cloud communications network;
thereby providing a first layer of security and privacy for the electronic content forwarded by the individual User for storage on the private cloud communications network.

2. The method of claim 1 wherein the private cloud communications network includes an electronic storage and retrieval service, a cloud computing platform for the electronic storage and retrieval service and a cloud computing infrastructure for an electronic content storage and retrieval service.

3. The method of claim 1 wherein the private cloud communications network includes on-demand electronic storage and retrieval services, broadband network access, and measured network services for the electronic content storage and retrieval services.

4. The method of claim 1 wherein the User, after authenticated log-in to the system, sends a request message from the User's PC, smartphone, iPhone, iPad, or similar mobile electronic device which includes a request for the desired electronic content stored in the plurality of private cloud storage objects and distributed across one or more of the networks comprising the private cloud communications network.

5. The method of claim 1 wherein the User's request is received by the private cloud network application, which retrieves securely the cloud content location map stored in the cloud application within the private cloud server network device and identifies the location address for the electronic content requested.

6. The method of claim 1 wherein the private cloud communications server securely sends in real-time the final desired electronic content from the identified address location within the plurality of cloud storage objects in the private cloud communications network to the User's chosen target PC, iPhone, iPad smartphone, tablet or other similar mobile electronic device.

7. The method of claim 6 wherein the electronic content sent to the User's chosen target electronic device is the product page of a merchant, retailer and/or seller whose product page is pre-coded with the Send2Mobile+ system and which pre-coded product page contains a “buy-now” icon.

8. The method of claim 6 wherein the User clicks on the “buy now” icon located on the retrieved product page and User's integrated mobile wallet information; together with User's shipping and billing information, stored in the private cloud is retrieved and activated for immediate payment for the product.

9. The method of claim 6 wherein the User clicks on the “Let Me Know” icon on the retrieved product page and User can choose from a plurality of events located in the drop-down menu of the Let Me Know function on the product page, such as when will product go on sale; what other models or colors does the product come in; I want to make a counter-offer for purchase of the product, I want to bid on the product; or I want to counter-bid on the product.

10. The method of claim 6 wherein the Send2Mobile+ enabled merchant, retailer and/or seller receives notification of the User's chosen event from within the drop-down menu residing on the product page and responds to the User's request, via the integrated SMS/MMS/EMS platform.

11. The method of claim 6 wherein the User clicks on the “Send to Me” icon located on the retrieved product page and chooses to send and share the retrieved product page to a friend, relative or other contact, enters the mobile device telephone number for the contact and sends the retrieved product page by text message via the integrated SMS/MMS/EMS platform.

12. A system for providing accurate location information for a moving electronic mobile device, the system comprising a location sensor coupled to the mobile device that determines the location of the mobile device;
a gyroscope, coupled to the mobile device that determines a direction of movement of the mobile device at the time of location of the mobile device;
a parameter setting module that sets parameters based upon the location sensor and gyroscope and compares the direction and location of the mobile device to an absolute location and external environment of the mobile device.

13. The method of claim 12 wherein the User is notified by text message via the integrated SMS/MMS/EMS platform, of the location of other S2M+ enabled stores, restaurants, hospitality, and/or other similar businesses, geographically located within a pre-defined parameter of the User's mobile device.

14. The method of claim 12 wherein the User is notified by text message, via the integrated SMS/MMS/EMS platform, of a plurality of events such as discounts, sales, special promotions at S2M+ enabled businesses geographically located within a pre-determined parameter of the User's mobile device.
